(19) United States
(12) Patent Application Publication
(10) Pub. No.: US 2024/0202844 A1
(43) Pub. Date: Jun. 20, 2024

(54) ELECTRIC VEHICLE FLEET MOBILE APPLICATION

(71) Applicant: IEMS Solution Ltd, Kitchener (CA)

(72) Inventors: Ashkan Rahimi-Kian, Kitchener (CA); Masoud Bashari, Kitchener (CA); Javad Zare, Kitchener (CA); Ehsan Saradar-Torshizi, Kitchener (CA); Kaveh Aflaki, Suwanee, GA (US)

(73) Assignee: IEMS Solution Ltd, Kitchener, ON (CA)

(21) Appl. No.: 18/511,930

(22) Filed: Nov. 16, 2023

Related U.S. Application Data
(60) Provisional application No. 63/432,428, filed on Dec. 14, 2022.

(51) Int. Cl. G06Q 50/06; B60L 53/68; G06Q 20/32

(52) U.S. Cl. CPC G06Q 50/06; B60L 53/68; G06Q 20/326

(57) ABSTRACT

A distributed energy resource management platform has a distributed energy resource management engine connected to a distribution system operator software agent, a driver software agent, an electric vehicle servicing entities software agent, and a blockchain service module connected to each software agent. An electric vehicle servicing entity platform with an electric vehicle servicing entity controller software module connects to at least one charging station. An advanced distribution management system platform and an electric vehicle driver platform is provided. The distributed energy resource management platform connects with the advanced distribution management system platform, the electric vehicle driver platform electronically, and the electric vehicle servicing entity platform through a network, such that the distributed energy resource management platform generates and manages at least one smart contract based on transactive energy web app data from the distribution system operator platform, metered data from the electric vehicle servicing entity platform, and transactive energy mobile data app data from the electric vehicle driver platform.

### CROSS REFERENCE TO RELATED APPLICATION

This application claims the benefit under 35 U.S.C. § 119(e) of co-pending U.S. Provisional Application No. 63/432,428 entitled “ELECTRIC VEHICLE FLEET MOBILE APPLICATION” filed Dec. 14, 2022, which is incorporated herein by reference.

### BACKGROUND

the growth of distributed renewable energy resources, electric vehicle (EV) charging stations and EV-fleets are experiencing a corresponding need for new resources and expanded loads. The need to connect to the power distribution grids increases over time. However, the current power distribution grids do not have the software infrastructure for modernized resource management required by the new demands.

EV fleets represent a particular challenge within this environment. Accordingly, there is a need for an improved electric vehicle fleet mobile application.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, an electric vehicle fleet mobile app includes a distributed energy resource management platform having a distributed energy resource management engine connected to a distribution system operator software agent, a driver software agent, an electric vehicle servicing entities software agent, and a blockchain service module connected to each software agent. An electric vehicle servicing entity platform with an electric vehicle servicing entity controller software module connects to at least one charging station. An advanced distribution management system platform and an electric vehicle driver platform is provided. The distributed energy resource management platform connects with the advanced distribution management system platform, the electric vehicle driver platform electronically, and the electric vehicle servicing entity platform through a network, such that the distributed energy resource management platform generates and manages at least one smart contract based on transactive energy web app data from the distribution system operator platform, metered data from the electric vehicle servicing entity platform, and transactive energy mobile data app data from the electric vehicle driver platform.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is an embodiment of a process flow for the electric vehicle fleet mobile app.

FIGS. 2A-2B depict another embodiment of a process flow for the electric vehicle fleet mobile app.

FIG. 3 is an exemplary user interface of the electric vehicle fleet mobile app.

FIG. 4 is an exemplary user interface of the electric vehicle fleet mobile app.

FIGS. 5A-5B depict an exemplary structure of the data engineering and

machine learning engineering components associated with the disclosed blockchain system.

FIG. 6 is a block diagram of a cloud-based computing system operable to execute the disclosed systems and methods in accordance with this disclosure.

FIG. 7 is a block diagram of a computing system operable to execute the disclosed systems and methods in accordance with this disclosure.

### DETAILED DESCRIPTION

The disclosure is directed to an electric vehicle mobile app that includes a user interface (UI) for electric vehicle registration. The user interface enables the software platform associated with the app to add features like brand, model, battery capacity and driver's charging and discharging preferences. The user interface is configured for showing the geographic information system (GIS) map of the area with all available charging stations, for grid-to-vehicle (G2V) and vehicle-to-grid (V2G) services and their respective energy prices to the EV driver within the next hour. The user interface is implemented for electronic wallet (or e-wallet) communication and integration for credit/debit update of each V2G/G2V service on a per-transaction basis. The user interface is further implemented to facility periodic financial settlement with the electric vehicle servicing entity (EVSE) firm.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

References to “Internet of Things” or “IoT” shall refer to smart systems and/or devices comprised of physical objects that are embedded with sensors, processing ability, software, and other technologies, and that connect and exchange data with other devices and systems over the Internet or other communications networks. The systems can represent a convergence of multiple technologies, including ubiquitous computing, commodity sensors, increasingly powerful embedded systems, and machine learning.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The subject disclosure is directed to a transactive energy (TE) platform within a cloud computing platforms for smart-grids with vehicle-to-grid (V2G) and grid-to-vehicle (G2V) services. The platform improves the electric distribution network reliability, stability, efficiency. The platform helps the grid operators make the power network more environment friendly by significantly reducing greenhouse gas via optimal utilization of clean energy resources. Further, the platform provides financial benefits for the EV drivers, EV serving entities (EVSE), and demand response (DR) aggregators. In various embodiments, the software architecture is scalable, secure, and deployable within all cloud platforms (i.e., AWS, MS Azure, Google and IBM).

An app is associated with a hybrid neural network model with long short-term memory (LSTM) and deep feedforward network (DFNN) for forecasting electric load and photovoltaic (PV) generation by using historical, meteorological and irradiation parameters. The app is also associated with fast and normal EV charging stations that are completely compatible with existing EV batteries. Additionally, scalable Proof of Reputation (POR) energy blockchain with off-chain Know-Your-Customer (KYC) is associated with the app, along with two-level Stackelberg game (or leader-follower game) formulation and optimization to find the stable Economic Game equilibrium between the grid operator and energy aggregators; and that for the energy aggregators and prosumers.

The electric vehicle mobile app comprises a user interface (UI) for electric vehicle registration. The user interface enables the software platform associated with the app to add features like brand, model, battery capacity and driver charging and discharging preferences.

The user interface is configured for showing the geographic information system (GIS) map of the area with all available charging stations, for grid-to-vehicle (G2V) and vehicle-to-grid (V2G) services and their respective energy prices to the EV driver within the next hour.

The user interface is implemented for electronic wallet (or e-wallet) communication and integration for credit/debit update of each V2G/G2V service on a per-transaction basis. The user interface is further implemented to facility periodic financial settlement with the electric vehicle servicing entity (EVSE) firm.

A Smart Contract to monitor the charging/discharging behavior of the EV-driver, when connected to the EV charging station (or EVSE) for proper debit/credit and creating reports, logs, invoices, etc.

A UI can show the EV driver the latest update regarding the EV battery's state of charge (SOC) and the amount of energy purchased (G2V service) or sold (V2G service). The information can be communicated to the EVSE firm for periodic financial settlements and to the DSO (or local grid operator) for the DERMS/OPF update and power flow. Further, grid assets' loading and effective EV demand response can be evaluated in real-time.

Real-time notifications to the EV driver with incentive prices to charge during off-peak demand hours (G2V service) and discharge during on-peak demand hours (V2G service).

The disclosed system includes an electric vehicle fleet mobile application for optimizing the electric vehicle fleet charging (including grid-to-vehicle, or G2V) and discharging (including vehicle-to-grid, or V2G) services, when interacting with the Electric Vehicle Supply Equipment (EVSE) or charging stations firms and power grid operators (i.e., DSO and LDC).

The electric vehicle fleet mobile app has several features that can be implemented through a number of user interfaces (UI), dashboards, or tabs. The features include electric vehicle registration, specification verifications, and charging preference management. The specifications can include brand, model, battery capacity and driver's charging and discharging preferences.

The electric vehicle fleet mobile app provides an UI for showing the geographical information (GIS) map of the area with all available charging stations for G2V and V2G services and their respective energy prices to the EV driver within the next hour

The electric vehicle fleet mobile app further provides notifications to the driver with incentive prices to charge during off-peak demand and discharge during on-peak demand hours.

The electric vehicle fleet mobile app can provide secure energy trading with the EVSE and/or the grid operator and financial settlements using the COSMOS Blockchain platform.

The mobile app on the driver's cell phone receives an offer from an EVSE agent and the EV driver can decide to either charge or discharge his/her EV car. The offer can include which can include energy, price, start-time, or time-duration.

The app utilizes smart contract to monitor the charging/discharging behavior of the EV-driver, when connected to the EV charging station (or EVSE) for proper debit/credit and creating reports, logs, invoices, etc.

The app is designed to work with internet-of-things (IoT) capable sensors (and their associated apps) on the electric vehicles to send the metered data to the blockchain transactive energy management platform. The metered data can include energy received, energy injected, and state of charge.

The app provides an UI for electronic wallet (or e-wallet) for credit/debit update per each V2G/G2V service, respectively, and periodic financial settlement with the EVSE firm.

The app provides an UI to show the EV driver the latest update regarding the EV battery's SOC (state of charge), amount of energy purchased (G2V service) or sold (V2G service), and communication of this crucial information with the EVSE firm, for periodic financial settlements, and the DSO (or local grid operator) for the DERMS/OPF update and power flow, grid assets loading and effective EV demand response evaluation in real-time.

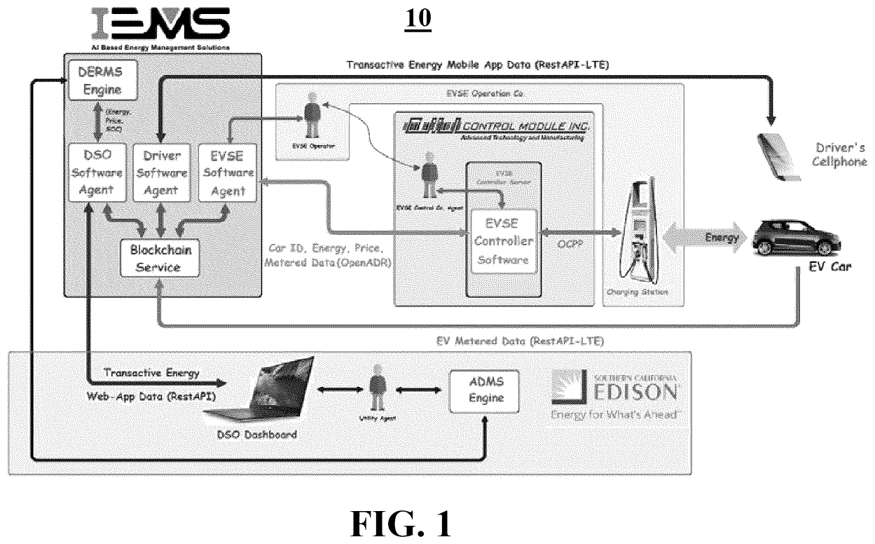

Referring to the drawings and, in particular, to FIG. 1, an exemplary flow process, generally designated by the numeral 10, of the electric vehicle fleet management app is shown. The electric vehicle management app is intended to be utilized in conjunction with a distribution energy resource management system (DERMS) software and a blockchain transactive energy (BCTE) platform. The app provides a user interface for various stakeholders (distribution system operators, electric vehicle drivers, and electric vehicle servicing entities, etc.) to utilize the DERMS software and BCTE platform to make informed decisions with forecast analysis and decentralized smart contract functions. In various embodiments, the configuration of the DERMS software and the BCTE platform would require modification and adaptation of the fleet management app, which is customizable in the user interface for persons with ordinary skills in the art.

In the exemplary embodiment, the electric vehicle management app is provided to a distribution system operator, an electric vehicle serving entity, and an electric vehicle driver. The UI has specific permissions for each user to access the information pertinent for each stakeholder user's functional intent. The users can access the management app on their intended devices. For an example, the electric vehicle driver can access the app on a mobile phone. Similarly, the distribution system operator can access the app on a laptop computer. It is envisioned that the app can be implemented on any personal computing devices that are foreseeably used in each stakeholder's position.

The structure of the app includes a distribution energy resource management system software that incorporates a blockchain module. The block chain module is configured to communicate with a number of software agent for each stakeholder. Each stakeholder has a dedicated software agent that would interact with the blockchain module for decentralized management operations. In the exemplary embodiment, the software agents include a distribution system operator software agent, a driver software agent, and an electric vehicle servicing entity software agent.

The distribution energy resource management system engine is connected to the distribution software agent. The DERMS engine is configured to communicate a number of attributes relevant to electric resource management with the DSO software agent. In the exemplary embodiment, the attributes include energy, price, and state of charge.

A utility agent within the distributor system operator domain can access energy transfer interactions through the app. Thus, an advanced distribution management system engine is provided to interface with the DERMS engine. The utility agent is also able to interact with the app via a distribution system operator dashboard, such that transactive energy data can be exchanged with the DSO software agent on the software platform through a web-data application programmed interface (API).

An electric vehicle driver can connect to the DERMS software platform through the app user interface. The driver's cellphone can be configured with the app to communicate with the driver software agent on the DERMS software platform. The driver's version of the app would allow exchange of transactive energy mobile app data between the driver and the software engine. The electric vehicle can be equipped with internet-of-things (IoT) capable sensors that would send metered data (including energy received by the vehicle, injected energy, and final state of charge) to the driver software agent.

Further, in the exemplary embodiment, an electric vehicle servicing operation company that offers a number of charging station can be connected to the software platform through an EVSE software agent. The EVSE software agent can be accessible by the EVESE operator or EVSE control company agent through a version of the user interface. The charging station offered by the EVSE operation company can further transfer data to the EVSE software agent. In the exemplary embodiment, the metered data transferred by the EVSE controller software can include car identification information, energy transferred, and transaction price. The EVSE controller software is configured to monitor the charging/discharging behavior of the electric driver when connected to the charging station, such that proper payment information can be monitored along with creation of reports, logs, and invoices, in various embodiments.

In operation, the electric vehicle driver, the EVSE operator, and the DSO agent access the DERMS software platform through the mobile app concurrently and separately. The electric vehicle fleet mobile app collects the pertinent metered information from the smart sensors located on the charging station and the electric vehicle and conducts automated predicative analysis on energy resource allocation within the network.

The blockchain module on the DERMS platform enables smart contract creation and negation among the software agents. A smart contract is used to monitor the charging and discharging behavior of the electric vehicle driver when connected to the EV charging station or EVSE establishments. In addition, the smart contract is used to keep track of the financial exchange associated with the energy transfer. Overall, the electric vehicle fleet mobile app provides a user interface to show the electric vehicle driver the latest update regarding the vehicle's battery state of charge, amount of energy purchased in a grid-to-vehicle service, energy sold in a vehicle-to-grid service, and more. The mobile app communicates the crucial information with the EVSE firm for periodic financial settlements. The mobile app further communicates with the DSO for DERMS and optimal power flow update in real time.

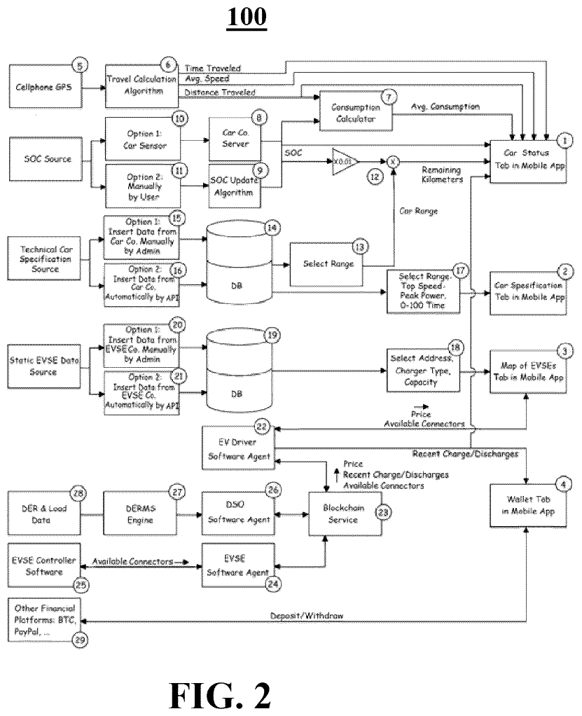

Referring to FIG. 2 with continuing reference to the foregoing figure, the process flow, generally designated with the numeral 100, of the electric vehicle fleet management app is shown. The electric vehicle app can be implemented in the software platform connecting the various stakeholders, as shown in FIG. 1. In the exemplary embodiment, the app comprises at least four tabs to display the relevant information, including car status, car specification, EVSE map, and wallet. It is envisioned that additional and various other tabs can be implemented on the app to suit the needs of specific stakeholders.

The car status tab includes the performance and energy consumption related information that can be collected through IoT capable sensors in the vehicles. The relevant information can be collected through a number of sources, such as cellphone GPS, state of charge source, and technical car specification source. In the exemplary embodiments, each data source can provide information that would be utilized by other tabs in addition to car status.

The cellphone GPS on the mobile phone with the app installed can utilize a travel calculation algorithm to generate the relevant information. The travel calculation algorithm can use this method to collect information such as travel time, average speed, and travel distance.

Distance traveled can further be utilized by a consumption calculator to generate average power consumption. The consumption calculator would further utilize information collected from the state of charge source. The state of charge source can provide information in various options. In an exemplary first option, a car sensor would be provided via a car company server to help provide state of charge information. In an exemplary second option, a state of charge data set can be manually provided by the user. The app would then utilize a state of charge update algorithm to generate state of charge information.

Additionally, the electric vehicle driver software agent can provide inputs on any recent charge or discharge. This would be provided in conjunction with sensor generated state of charge data and GPS data, for the car status tab to display an overview of the relevant electric vehicle configuration.

Car specification tab is configured to extract information from technical car specification sources. In the exemplary first option, the data is inserted from car company manually be manufacturing admin. In the exemplary second option, an API is programed to insert the data automatically into a database. The database contains the car specification data that would be displayed on the tab. Such information would include, for example, top speed, peak power, acceleration time from 0-100 miles per hour. The technical specification information is the design spec for the car and is independent of the performance that the car produces at any time.

In an exemplary scenario, the car status tab and the car specification tab would analyze the respective datasets jointly to arrive at additional dataset. The app would utilize the state of charge information from the sensors and evaluate it against the car specification to calculate remaining achievable distance of the vehicle, as an example. It is envisioned that the combined analysis of various dataset would provide insight into the vehicle charge and performance that is relevant for specific stakeholders.

The EVSE map would provide the electric vehicle charge and service providers in the area. Similar to the car specification source, the static EVSE data source have various options of inputting data into the EVSE database. In the first exemplary embodiment, data is inserted into the database manually by EVSE company admin. In a second exemplary embodiment, an API is programmed to insert the data automatically into a database. The EVES map would allow users to select address, charger type, or capacity, in an exemplary embodiment, to display the EVSE location options in the proximity. The EVSE map would further be capable of extracting price and available connections from servicing entities in connection with the EV driver software agent.

The EV driver software agent, in providing recent charge/discharge information to the car status tab in the app, can concurrently provide the information to the wallet tab in the app. The wallet tab is further connected to external financial platforms in order to facilitate payment management and fulfilment options.

In viewing the process flow diagram of both FIG. 1 and FIG. 2, a person with ordinary skills in the art would understand that blockchain modalities are implemented in managing the financial transactions through smart contracts between stakeholders. The block chain service is implemented to communicate with EV driver software agent, DSO software agent, and EVSE software agent.

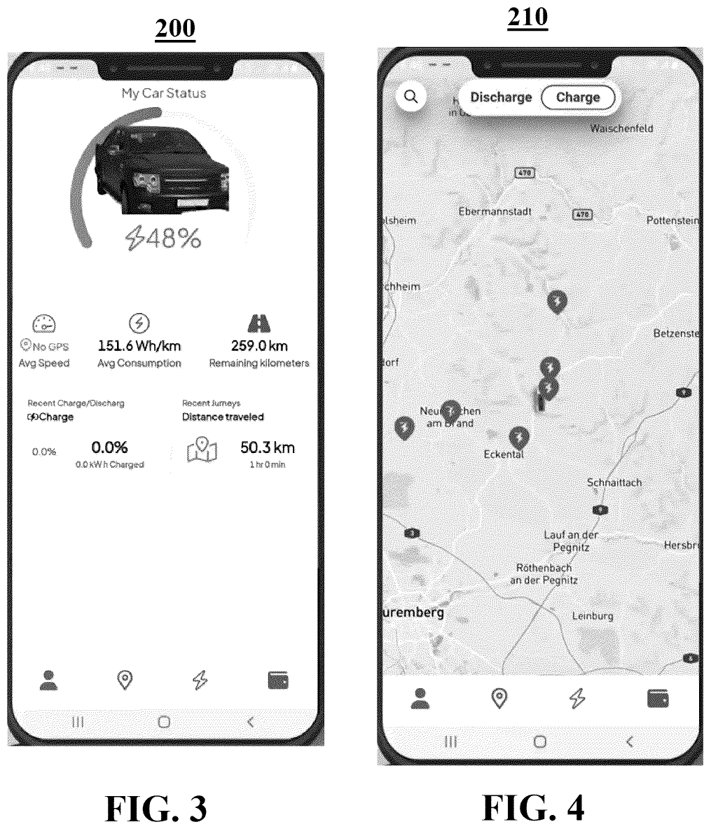

Referring to FIG. 3 with continuing reference to the foregoing figures, an exemplary embodiment of a user interface, generally designated by the numeral 200, is shown. This can be a car status tab as shown in FIG. 2. In this embodiment, the tab shows the car's current state of charge, average speed, average consumption, remaining distance, recent charge/discharge, and the current distance traveled.

Referring to FIG. 4 with continuing reference to the foregoing figures, an exemplary embodiment of a user interface, generally designated with the numeral 210, is shown. This can be an EVSE map tab as shown in FIG. 2. In this embodiment, the tab shows the available charging stations or EVSE stations within the vicinity of the designated location. In other embodiments, the available charging connections are also displayed on this tab.

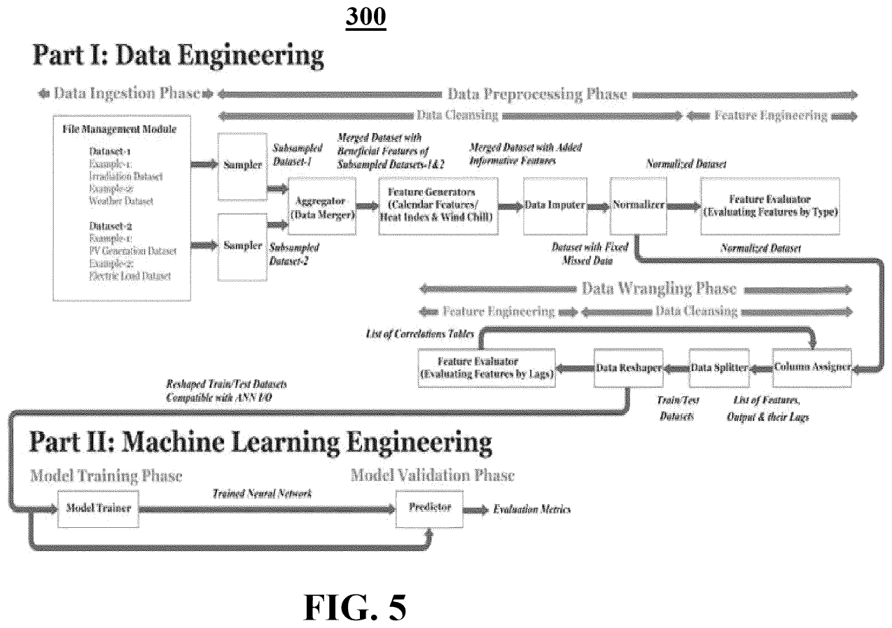

Referring to FIG. 5 with continuing reference to the foregoing figures, an exemplary structure, generally designated with the numeral 300, for data and machine learning engineering associated with the electric vehicle fleet mobile app is illustrated. These two exemplary parts can be implemented into the software engine to facilitate the forecasting function. In various embodiments, data engineering would be implemented to provide input data and parameters for artificial neural network training methodologies.

In general, data engineering aspect of the system would function through a number of phases. In an exemplary embodiment, data engineering comprises data ingestion phase, data processing phase, and data wrangling phase. The data process phase can further comprise of data cleansing and feature engineering. The data wrangling phase further incorporate feature engineering and data cleansing.

In the data ingestion phase, a file management module is provided. This can be implemented as a standalone database or as a part of a comprehensive database in larger system. FIG. 4 illustrates a number of datasets that could be stored in this management module. The dataset can be used to store and provide input for data used by the DERMS engine in FIG. 1.

The data from the file management module can be extracted to go through the data process phase. In this exemplary phase, the data can go be processed through a data cleansing step. During this procedure, at least one sampler from a dataset in the file management module is collected by an aggregator or data merger. The aggregator provides the function to merge a number of datasets with their beneficial features.

Next, the merged datasets will be merged further with added informative features. This can be achieved by features generators. In this embodiment, the features generator can generate features on calendar features, heat index, and wind chill. The merged database with added informative features is processed through a data imputer and a normalizer. At this step, the datasets are transformed into normalized datasets.

Finally, the normalized dataset is processed through a feature engineering step. In the exemplary embodiment, a feature evaluator is provided to evaluate the features incorporated into the normalized dataset. The resultant data would be ready for further predicative processing in the software engine.

### Exemplary Cloud Architecture

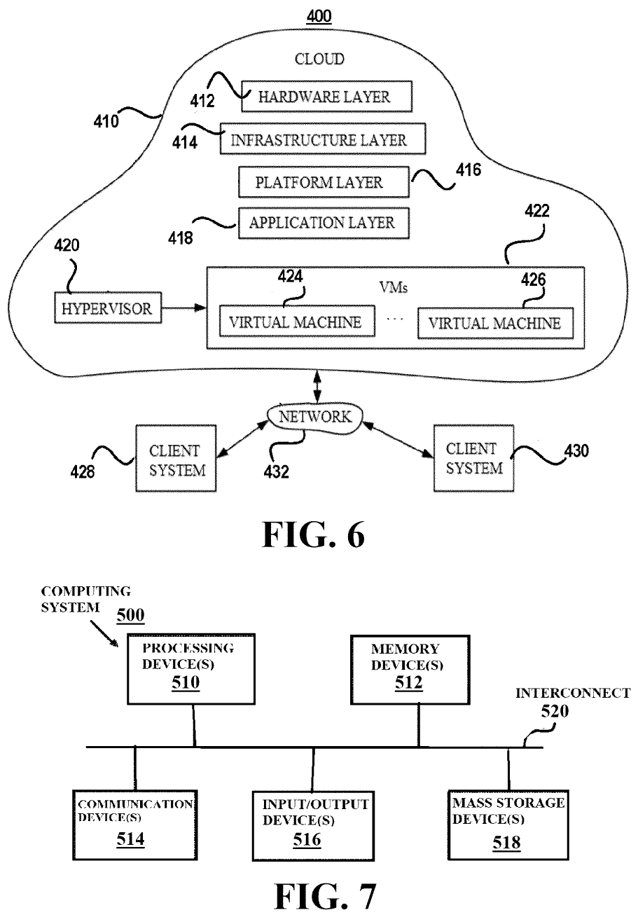

Referring to FIG. 6 with continuing reference to the foregoing figures, exemplary cloud architecture, generally designated by the numeral 400, for practicing the process 10 shown in FIG. 1 and/or the process 100 shown in FIG. 2 is illustrated. Further, the architecture 400 can be used to implement the user interface 200 shown in FIG. 3, the user interface 210 shown in FIG. 4, and/or the structure 300 shown in FIG. 5. The exemplary cloud architecture 400 provides computation, software, data access, and storage services that do not require end-user knowledge of the physical location or configuration of the system that delivers the services. In various embodiments, cloud computing delivers the services over a wide area network, such as the internet, using appropriate protocols.

For instance, cloud computing providers deliver applications over a wide area network and they can be accessed through a web browser or any other computing component. Software or components of architecture 400 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud can be managed by the organization itself and the infrastructure is typically not shared with other organizations. The organization still maintains the hardware to some extent, such as installations and repairs, etc.

As shown in FIG. 6, the cloud architecture 400 includes a cloud 410. The cloud 410 (or each of the different premises on the cloud 410) can include a hardware layer 412, an infrastructure layer 414, a platform layer 416, and an application layer 418.

A hypervisor 420 can illustratively manage or supervise a set of virtual machines 422 that can include a plurality of different, independent, virtual machines 424-426. Each virtual machine can illustratively be an isolated software container that has an operating system and an application inside it. It is illustratively decoupled from its host server by hypervisor 420. In addition, hypervisor 420 can spin up additional virtual machines or close virtual machines, based upon workload or other processing criteria.

A plurality of different client systems 428-430 (which can be end user systems or administrator systems, or both) can illustratively access cloud 410 over a network 432. Depending upon the type of service being used by each of the client systems 428-430, cloud 410 can provide different levels of service. In one example, the users of the client systems are provided access to application software and databases. The cloud service then manages the infrastructure and platforms that run the application. This can be referred to as software as a service (or SaaS). The software providers operate application software in application layer 418 and end users access the software through the different client systems 428-430.

The cloud provider can also use platform layer 416 to provide a platform as a service (PaaS). This involves an operating system, programming language execution environment, database and webserver being provided to the client systems 428-430, as a service, from the cloud provider. Application developers then normally develop and run software applications on that cloud platform and the cloud provider manages the underlying hardware and infrastructure and software layers.

The cloud provider can also use infrastructure layer 414 to provide infrastructure as a service (IaaS). In such a service, physical or virtual machines and other resources are provided by the cloud provider, as a service. These resources are provided, on-demand, by the IaaS cloud provider, from large pools installed in data centers. In order to deploy the applications, the cloud users that use IaaS install operating-system images and application software on the cloud infrastructure 400.

### Exemplary Computer System

Referring now to FIG. 7 with continuing reference to the forgoing figures, an exemplary computing system, generally designated by the numeral 500, for use implementing aspects of the process 10 shown in FIG. 1 and/or the process 100 shown in FIG. 2 is illustrated. Further, the computing system 500 can be used to implement aspects of the user interface 200 shown in FIG. 3, the user interface 210 shown in FIG. 4, and/or the structure 300 shown in FIG. 5.

The hardware architecture of the computing system 500 that can be used to implement any one or more of the functional components described herein. In some embodiments, one or multiple instances of the computing system 500 can be used to implement the techniques described herein, where multiple such instances can be coupled to each other via one or more networks.

The illustrated computing system 500 includes one or more processing devices 510, one or more memory devices 512, one or more communication devices 514, one or more input/output (I/O) devices 516, and one or more mass storage devices 518, all coupled to each other through an interconnect 520. The interconnect 520 can be or include one or more conductive traces, buses, point-to-point connections, controllers, adapters, and/or other conventional connection devices. Each of the processing devices 510 controls, at least in part, the overall operation of the processing of the computing system 500 and can be or include, for example, one or more general-purpose programmable microprocessors, digital signal processors (DSPs), mobile application processors, microcontrollers, application-specific integrated circuits (ASICs), programmable gate arrays (PGAs), or the like, or a combination of such devices.

Each of the memory devices 512 can be or include one or more physical storage devices, which can be in the form of random-access memory (RAM), read-only memory (ROM) (which can be erasable and programmable), flash memory, miniature hard disk drive, or other suitable type of storage device, or a combination of such devices. Each mass storage device 518 can be or include one or more hard drives, digital versatile disks (DVDs), flash memories, or the like. Each memory device 512 and/or mass storage device 518 can store (individually or collectively) data and instructions that configure the processing device(s) 510 to execute operations to implement the techniques described above.

Each communication device 514 can be or include, for example, an Ethernet adapter, cable modem, Wi-Fi adapter, cellular transceiver, baseband processor, Bluetooth or Bluetooth Low Energy (BLE) transceiver, serial communication device, or the like, or a combination thereof. Depending on the specific nature and purpose of the processing devices 510, each I/O device 516 can be or include a device such as a display (which can be a touch screen display), audio speaker, keyboard, mouse or other pointing device, microphone, camera, etc. Note, however, that such I/O devices 516 can be unnecessary if the processing device 510 is embodied solely as a server computer.

In the case of a client device, the communication devices(s) 514 can be or include, for example, a cellular telecommunications transceiver (e.g., 3G, LTE/4G, 5G), Wi-Fi transceiver, baseband processor, Bluetooth or BLE transceiver, or the like, or a combination thereof. In the case of a server, the communication device(s) 514 can be or include, for example, any of the aforementioned types of communication devices, a wired Ethernet adapter, cable modem, DSL modem, or the like, or a combination of such devices.

A software program or algorithm, when referred to as “implemented in a computer-readable storage medium,” includes computer-readable instructions stored in a memory device (e.g., memory device(s) 512). A processor (e.g., processing device(s) 510) is “configured to execute a software program” when at least one value associated with the software program is stored in a register that is readable by the processor. In some embodiments, routines executed to implement the disclosed techniques can be implemented as part of OS software (e.g., MICROSOFT WINDOWS® and LINUX®) or a specific software application, algorithm component, program, object, module, or sequence of instructions referred to as “computer programs.”

Computer programs typically comprise one or more instructions set at various times in various memory devices of a computing device, which, when read and executed by at least one processor (e.g., processing device(s) 510), will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium (e.g., the memory device(s) 512).

The detailed description provided above in connection with the appended drawings is intended as a description of examples and is not intended to represent the only forms in which the disclosed examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

### Supported Features and Embodiments

The detailed description provided above in connection with the appended drawings explicitly describes and supports various features of an electric vehicle fleet mobile application. By way of illustration and not limitation, supported embodiments include an electric vehicle fleet mobile app comprising: a distributed energy resource management platform comprising a distributed energy resource management engine connected to a distribution system operator software agent, a driver software agent, an electric vehicle servicing entities software agent, and a blockchain service module connected to each software agent, an electric vehicle servicing entity platform with an electric vehicle servicing entity controller software module connected to at least one charging station, an advanced distribution management system platform, and an electric vehicle driver platform, wherein the distributed energy resource management platform connects with the advanced distribution management system platform, the electric vehicle driver platform electronically, and the electric vehicle servicing entity platform through a network, such that the distributed energy resource management platform generates and manages at least one smart contract based on transactive energy web app data from the distribution system operator platform, metered data from the electric vehicle servicing entity platform, and transactive energy mobile data app data from the electric vehicle driver platform.

Supported embodiments include the foregoing mobile app, wherein the electric vehicle driver platform is connected to at least one sensor, wherein the sensor has Internet-of-Things capability.

Supported embodiments include any of the foregoing mobile apps, wherein the smart contract the software agents can manage and accept offers of smart contracts.

Supported embodiments include any of the foregoing mobile apps, wherein the electric vehicle serving entity platform is implemented on a grid-to-vehicle system and transmits fleet charging service data.

Supported embodiments include any of the foregoing mobile apps, wherein the electric vehicle serving entity platform is implemented on a vehicle-to-grid system and transmits fleet discharging service data.

Supported embodiments include any of the foregoing mobile apps, wherein the electric vehicle driver platform receives and transmits at least one incentive price data.

Supported embodiments include any of the foregoing mobile apps, further comprising at least one user interface for said platforms.

Supported embodiments include any of the foregoing mobile apps, wherein the user interface includes a vehicle status tab, a vehicle specification tab, and an electric vehicle servicing entity map tab, and an electronic wallet tab.

Supported embodiments include any of the foregoing mobile apps, wherein the user interface provides for managing locational marginal pricing data.

Supported embodiments include a method for managing electric vehicle fleet with a mobile app, comprising: providing a distributed energy resource management platform comprising a distributed energy resource management engine connected to a distribution system operator software agent, a driver software agent, an electric vehicle servicing entities software agent, and a blockchain service module connected to each software agent, providing an electric vehicle servicing entity platform with an electric vehicle servicing entity controller software module connected to at least one charging station, providing an advanced distribution management system platform, providing an electric vehicle driver platform, and connecting the distributed energy resource management platform with the advanced distribution management system platform, the electric vehicle driver platform electronically, and the electric vehicle servicing entity platform through a network, such that the distributed energy resource management platform generates and manages at least one smart contract based on transactive energy web app data from the distribution system operator platform, metered data from the electric vehicle servicing entity platform, and transactive energy mobile data app data from the electric vehicle driver platform.

Supported embodiments include an apparatus, a device, a computer-readable storage medium, a computer program product and/or means for implementing any of the foregoing systems, methods, or portions thereof.

The detailed description provided above in connection with the appended drawings is intended as a description of examples and is not intended to represent the only forms in which the disclosed examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

1: An electric vehicle fleet mobile app comprising:
a distributed energy resource management platform comprising a distributed energy resource management engine connected to a distribution system operator software agent, a driver software agent, an electric vehicle servicing entities software agent, and a blockchain service module connected to each software agent,
an electric vehicle servicing entity platform with an electric vehicle servicing entity controller software module connected to at least one charging station,
an advanced distribution management system platform, and
an electric vehicle driver platform,
wherein the distributed energy resource management platform connects with the advanced distribution management system platform, the electric vehicle driver platform electronically, and the electric vehicle servicing entity platform through a network, such that the distributed energy resource management platform generates and manages at least one smart contract based on transactive energy web app data from the distribution system operator platform, metered data from the electric vehicle servicing entity platform, and transactive energy mobile data app data from the electric vehicle driver platform.

2: The mobile app of claim 1, wherein the electric vehicle driver platform is connected to at least one sensor, wherein the sensor has Internet-of-Things capability.

3: The mobile app of claim 1, wherein the smart contract the software agents can manage and accept offers of smart contracts.

4: The mobile app of claim 1, wherein the electric vehicle serving entity platform is implemented on a grid-to-vehicle system and transmits fleet charging service data.

5: The mobile app of claim 1, wherein the electric vehicle serving entity platform is implemented on a vehicle-to-grid system and transmits fleet discharging service data.

6: The mobile app of claim 1, wherein the electric vehicle driver platform receives and transmits at least one incentive price data.

7: The mobile app of claim 1, further comprising at least one user interface for said platforms.

8: The mobile app of claim 7, wherein the user interface includes a vehicle status tab, a vehicle specification tab, and an electric vehicle servicing entity map tab, and an electronic wallet tab.

9: The mobile app of claim 7, wherein the user interface provides for managing locational marginal pricing data.

10: A method for managing electric vehicle fleet with a mobile app, comprising:
providing a distributed energy resource management platform comprising a distributed energy resource management engine connected to a distribution system operator software agent, a driver software agent, an electric vehicle servicing entities software agent, and a blockchain service module connected to each software agent,
providing an electric vehicle servicing entity platform with an electric vehicle servicing entity controller software module connected to at least one charging station,
providing an advanced distribution management system platform,
providing an electric vehicle driver platform, and
connecting the distributed energy resource management platform with the advanced distribution management system platform, the electric vehicle driver platform electronically, and the electric vehicle servicing entity platform through a network, such that the distributed energy resource management platform generates and manages at least one smart contract based on transactive energy web app data from the distribution system operator platform, metered data from the electric vehicle servicing entity platform, and transactive energy mobile data app data from the electric vehicle driver platform.
